(19) United States
(12) Patent Application Publication
(10) Pub. No.: US 2008/0111406 A1
(43) Pub. Date: May 15, 2008

(54) Vehicle safety system with deployable lateral restraints

(76) Inventor: Keith Friedman, Santa Barbara, CA (US)

Correspondence Address: MARK RODGERS, 1590 SAN ROQUE ROAD, SANTA BARBARA, CA, 93105, US

(21) Appl. No.: 11/904,971

(22) Filed: Sep. 27, 2007

Related U.S. Application Data
(63) Continuation-in-part of application No. 10/916,564, filed on Aug. 12, 2004, now abandoned.

(51) Int. Cl. B60N 2/42; B60R 21/02

(52) U.S. Cl. 297/216.1; 297/464

(57) ABSTRACT

This invention is a vehicle safety system which provides lateral passenger restraint for certain accident events. The invention consists of lateral occupant restraints which are deployed in response to an indication that an appropriate event has occurred, or are deployed during operation of the vehicle.

### RELATED APPLICATIONS

This application is Continuation-in-Part of U.S. application Ser. No. 10/916,564, filed Aug. 12, 2004

### FEDERALLY SPONSORED RESEARCH

Not Applicable

### SEQUENCE LISTING

Not Applicable

### BACKGROUND OF THE INVENTION

The invention relates to vehicle safety, particularly for automobiles and light trucks, but is also applicable to heavy vehicles or aircraft. The system of this invention will provide increased occupant protection in the event of a rollover accident or side impact accident, or other situations where safety is enhanced by reducing lateral motion of the occupant.

Safety devices, such as side air curtains, are currently used in vehicles to prevent lateral occupant motion. However, current safety devices of this type are only positioned on the door or outboard side of the occupant. For opposite side impacts, lateral restraint is highly desirable on the inboard side. Moreover lateral restraint on the outboard side that more closely connects the occupant to the structure of the vehicle has been shown to be effective.

Fixed lateral restraints have been proposed as comfort enhancing devices for high performance vehicles to keep occupants centered during high speed turns. However the need for lateral safety devices that automatically deploy before or during certain types of accidents is critical to achieving enhanced occupant protection. It has been shown that lateral restraints provide significant advantage for oblique impacts, up to over 90 degrees as the occupant is prevented from having excessive lateral motion. Without lateral restraint, the occupant rotates to the side potentially exposing the occupant to hazardous contacts. Side restraints also bring the occupant to rest faster by providing a connection to the vehicle, dissipating the collision imparted velocities at the vehicle “ride down curve”, which often results in lower trauma impacts if the occupant does strike a part of the vehicle. In addition, for rollover accidents, lateral restraints will prevent the occupant from being ejected or partially ejected from the seat to the side. The current invention addresses the need for lateral occupant restraint in a manner that can be applied and used.

### BRIEF SUMMARY OF THE INVENTION

The invention is a safety system for a vehicle, consisting of a seat and at least one sensor for detecting a condition requiring deployment of safety devices. The invention uses at least one lateral restraint. In response to a signal from the sensor, a side restraint is deployed on at least one side of the seat to restrain the seat occupant from being displaced laterally.

In the preferred embodiment the lateral restraint is deployed by being rotated into position such that after deployment, the restraint serves as a side barrier. The restraint may also be deployed by being moved laterally until it is in contact or close proximity to the occupant. The restraint may also be positioned vertically to adjust for occupant size. The restraint may also be rotated, positioned laterally, and positioned vertically all in one implementation.

In one embodiment, the lateral restraint is rotated by a motor. In one version of this embodiment, the motor is used for occupant controlled adjustment of the lateral restraint position during normal operation for comfort, and automatically rotates to a safety position in response to the sensor signal. In another embodiment the lateral restraint is rotated by a spring rotator, such that the spring is released in response to the sensor signal. The spring loaded implementation also supports manual adjustment of the restraint position. In a further embodiment the lateral restraint is rotated by a pyrotechnic device, such that the pyro is fired in response to the sensor signal.

Another embodiment contains a locking device to secure the lateral restraint in the safety position. In one version, a stop is inserted when the restraint reaches the desired point of rotation. In a further embodiment the sensor(s) communicates with a smart safety system, and the action of the lateral restraints is controlled by the safety system. In another embodiment, the lateral restraint is partially deployed when the seat is occupied, and fully deployed in response to the sensor signal.

In one embodiment, the side restraint is unrolled in response to the sensor signal. In another, the lateral restraint is part of the seat, such the seat is pre-stressed to assume a shape with the lateral restraint deployed. The seat is held in the non-deployed shape by a rigid internal structure, and the internal structure is rendered non rigid in response to the sensor signal such that the seat assumes a shape with lateral restraints deployed.

In another embodiment the sensor signal is triggered by one or more of the following: a rollover condition; a side impact; an anticipatory event such as a vehicle side slip, high lateral deceleration, high yaw rate, high roll rate, high deceleration braking or, pre-collision detection; or the vehicle commencing operation. In one embodiment, the collision detection system is a radar collision detection system. In a further embodiment, if no collision results from the anticipatory event, the restraints are returned to their pre-event position.

In a preferred embodiment, at least one lateral restraint, sufficient to withstand impact level stresses is deployed into a safety position at a start vehicle operation event, and moved into a stowed position at a stop vehicle operation event. Start vehicle operation events may include any combination of vehicle movement, seat-belt use, passenger detection by weight sensor or, car doors closed. Stop vehicle operation events may include any combination of vehicle motion stopped, vehicle taken out of gear, seat belt removed or, car door opened. In other embodiments, the restraint may be stowed attached to a side of the seat back or integral to the seat back, and the deployment by motor. The lateral restraint may optionally contain side airbags, either positioned to deploy above the restraint, below the restraint, between the restraint and a seat occupant, or any combination of the above.

### BRIEF DESCRIPTION OF THE DRAWINGS

The detailed description of how to make and use the invention will be facilitated by referring to the accompanying drawings.

FIG. 1 shows a top view of the an embodiment of the invention.

FIG. 2 illustrates the operation of the lateral restraints.

FIG. 3 shows one embodiment of the invention

FIG. 4 shows another embodiment.

FIG. 5 shows a further embodiment

FIG. 6 shows an embodiment of the invention where the restraint is deployed whenever the vehicle is operating.

FIG. 7 shows an alternative version of the embodiment of FIG. 6.

### DETAILED DESCRIPTION OF THE INVENTION

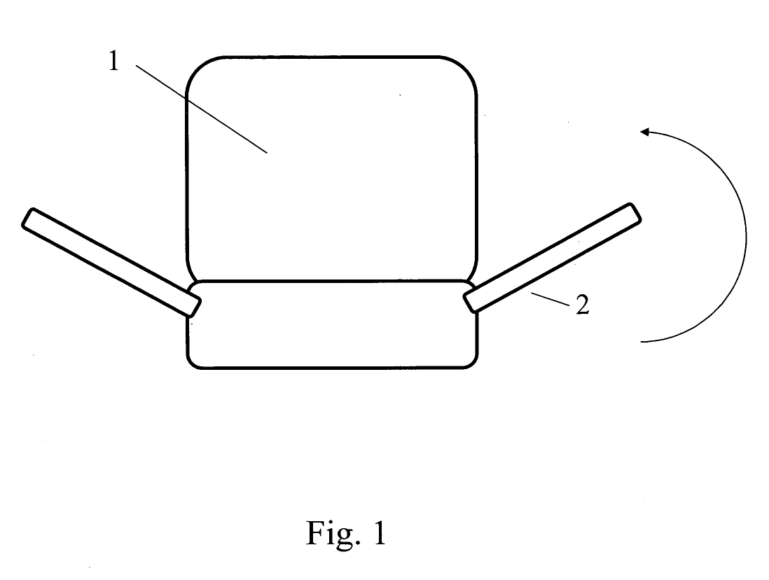

Referring to FIG. 1, a vehicle seat 1 is shown. This seat may be of a variety of designs known in the art. Shown also are two lateral restraints 2 which are depicted during deployment. Preferably, two restraints will be used, one on each side, although the invention applies equally to the case where only one restraint is used. The non-deployed position may be anywhere that the design of the vehicle allows for and is convenient to the occupant for non-accident conditions. Thus the restraints, for example, may be advantageously in a position that allows for easy entrance into the seat when not deployed.

The deployed position ideally should be such that the occupant is substantially prevented from moving laterally, but not such that the occupant is held too tight. The deployed position is preferably near 90 degrees to the seat back. As will be described later, the actual deployed position is seat dependent. For vehicles with occupant sensing and intelligent safety systems, the restraints may be adaptable for different occupants. Although deployable lateral restraints exist in the prior art, to date they are envisioned as providing firmer occupant positioning during cornering or high speed handling. It is important to note that lateral forces of around 1 g are as high as will be encountered in normal vehicle operation. Thus prior art restraints are designed with relatively low forces in mind. Furthermore, the deployment of these existing restraints must not interfere with the operation of the vehicle. The combination of these two factors dictates design requirements that are not in any way compatible with lateral restraints aimed at securing an occupant laterally in an impact situation. For an impact situation, G loads of 10 or higher must be designed for, and not only is it acceptable to interfere with the ability to operate the vehicle during deployment, in some cases it may be necessary. One skilled in the art will understand that prior art deployable lateral restraints do not lend themselves in any way to provide occupant safety in an impact/rollover situation.

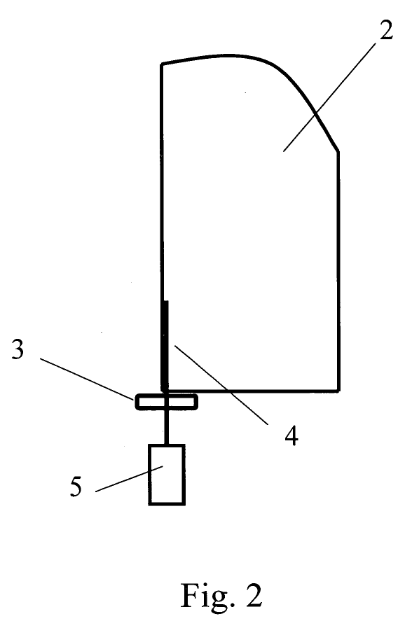

The detailed operation of the invention is as follows. Referring to FIG. 2, the side restraints 2 are shown as rotatable members. Other configurations are possible. For instance the side restraints could be arranged such that they are moved forward from pockets or the side of the seat when deployed. However, the inventors feel that rotating toward the occupant is a safe way to deploy side restraints, and thus rotating members is one preferred implementation. The restraints, as shown in the figure, may be in a variety of deployed and non-deployed positions, within the scope of the invention. The exact deployed and non-deployed positions depend on vehicle design. It is important to understand that a design that allows for both a fully stowed and a fully deployed capability is the most complete implementation of the invention. However any implementation is desirable that allows the occupant access to the seat and the ability to operate the vehicle, but still provides a degree of lateral restraint in the event of an accident, given that the implementation is adequate to withstand impact level loads.

The invention includes a trigger to cause deployment of the restraints and a mechanism to accomplish the deployment. It is contemplated that the vehicle will have sensors that will sense different types of accident or operational events that would cause deployment. Applicable events include rollover, side impact, and oblique impact accidents. Side restraints on the window side, in conjunction with other rollover safety systems, would be highly beneficial in a rollover accident. The rollover sensor, either directly or through a smart safety system controller, would initiate the deployment of the restraints. Oblique and side impacts are much faster than rollover accidents, so it would be beneficial to begin deployment of a mechanical restraint as early as possible by anticipating a problem. Anticipatory trigger events include any combination of detection of a vehicle side slip, high lateral deceleration, yaw rate, roll rate, high deceleration braking and collision detection such as by radar. Or input from other systems like ESC system or side curtain systems may provide anticipatory information. Such systems are increasingly available on vehicles. For an anticipatory deployment, it would be advantageous for the smart safety system to remember the predeployment position of the restraints, and in the event no accident takes place, return the restraints to the predeployed configuration. It is also possible to deploy the side restraints as soon as the seat is occupied, or the vehicle begins to move, at least to a useful extent. This scenario is described in further detail below. An alternative is to partially deploy the restraints when the seat is occupied, such that full deployment in an emergency situation requires less time.

Many materials and construction techniques for the restraints will be apparent to one skilled in the art. Conventional cushions, cushions that include airbags, or airbags alone are all possible choices. Structures that compress, including modern designs that compress with a substantially constant spring force are also suitable, as are multi-level force resistant structures utilizing energy absorbent materials to interface to the occupant. The size, materials used, and shape will vary with the seat design and available space, but must be chosen with impact level loads as a requirement. A possible implementation is a layered restraint. The outer layer is a cushion in contact with the occupant, the next inner layer is an energy absorbent material, and the innermost layer is a structure, which may also be energy absorbent. Such a restraint could be two or one-sided, depending on the positioning in the vehicle.

Referring to FIG. 2, the restraint 2 is connected by a coupling mechanism, 4, typically a rotatable shaft, to an actuator 5. Depending on the type of actuator, a locking mechanism 3 may be required to keep the restraint in the deployed position. Several different actuator types may be employed in the invention. One type of actuator is a motor. The sensor signal would trigger high speed rotation of the motor axis, which in turn rotates the restraint. The advantage of a motor actuator is that it also provides the possibility of powered user adjustment of the restraints during normal vehicle operation. The motor implementation would operate similarly to the invention described in co-pending application Ser. No. 10/807,325. Normal power adjustment of the restraints could operate at lower speed, while accident deployment would trigger a high power operation of the motor resulting in high speed rotation of the restraints. The motor implementation could support both a measured deployment rotation, with a device such as a rotary encoder, or rotate to a stop. Depending on the type of motor and coupling, the locking mechanism may not be required. The advantage of the motor implementation is straightforward compatibility with memory functions such as described above for anticipatory triggers, or simply to remember occupant characteristics. The occupant selected position of the lateral restraints could be remembered for each occupant along with the other occupant selected seat positions currently remembered by many existing powered seats.

A variety of spring actuators known in the art may be employed at 5. Spring actuators typically will require the locking mechanism 3. A locking mechanism could be as simple as spring loaded pin (or pins) that is released into a slot when the restraint reaches the point of desired rotation. Many suitable locking mechanisms will suggest themselves to one skilled in the art. Spring loaded implementations with locking mechanisms also lend themselves to user manual adjustment of the restraint position, similarly to the operation of manual reclining mechanisms. A pyrotechnic mechanism similar to those employed in seat belt pretensioners may also be employed. The sensor signal triggers the pyrotechnic piston which rolls up a cable or belt, attached to the shaft 4. The roll-up causes the restraint shaft to rotate. A pyro actuator will likely require a locking mechanism

In many vehicles, a smart safety controller may be employed. Such a system will accept the various sensor signals, such as the rollover sensor, and make decisions about safety device deployment depending on a variety of measured factors. Such factors are occupant presence, size, and weight. In such a system, the side restraint deployment may be modified according to the factors. For instance, for a large seat occupant, the amount of rotation of the restraints may be less than for a smaller occupant. For the implementation of the invention with motor actuators and encoders, fine control of restraint deployment could be easily achieved. Or, the restraints could have sensors built in to indicate when the restraint has contacted the occupant, or is close to the occupant, and cease rotation accordingly.

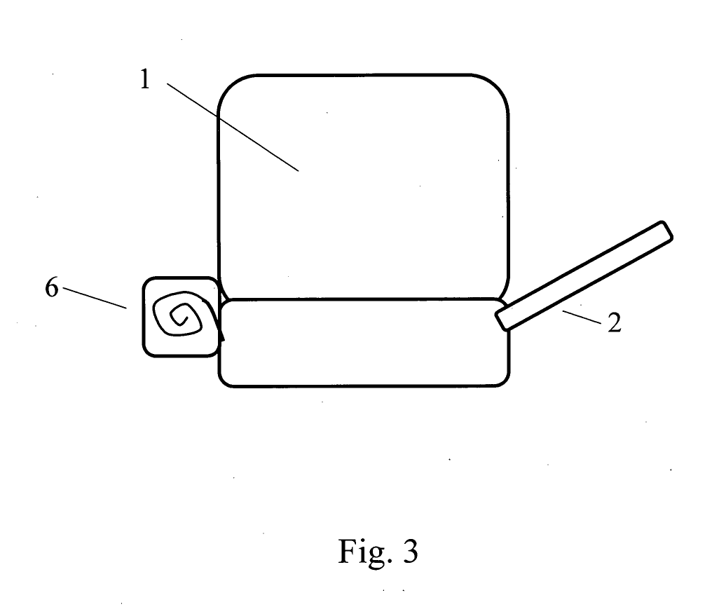

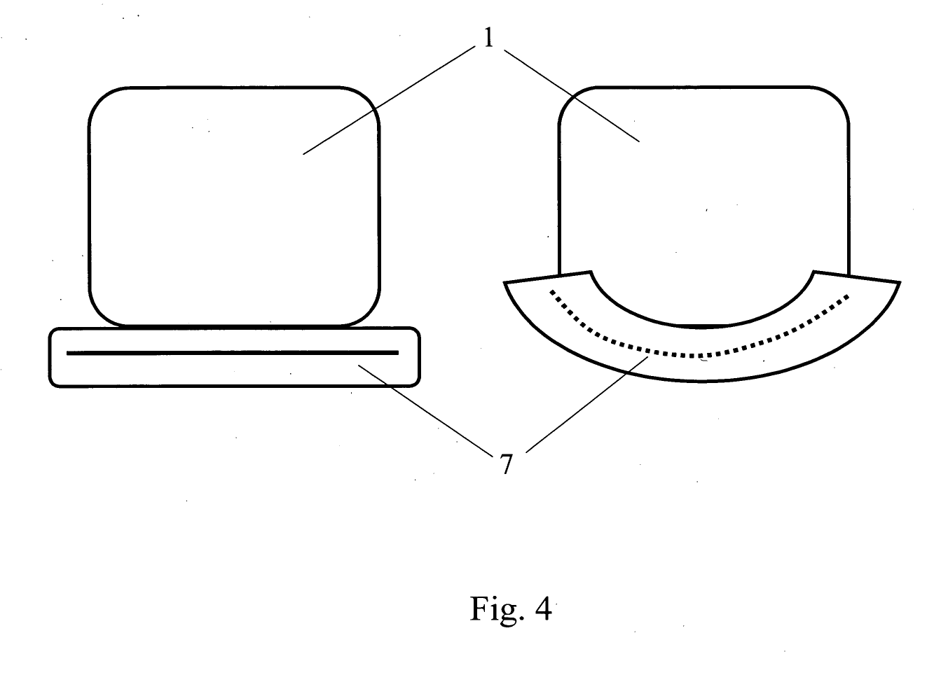

Other deployment mechanisms are contemplated as well. Referring to FIG. 3, the side restraint may be rolled up in the non-deployed position such that it is compact and out of the way, as shown at 6. When triggered, the restraint may be unfurled either with pressurized gas similar to airbags, or by releasing a spring unfurling mechanism. Another approach is shown in FIG. 4. The seat back may be constructed such that it is pre-stressed to have a natural shape that provides lateral restraint. The seat can be held in a conventional shape by a rigid structural support 7. The support 7 may be removed in an emergency situation which will allow the seat to assume the shape that includes lateral restraint. A variety of ways could be employed to remove the support, such as breaking it with a pyro charge triggered by a sensor signal.

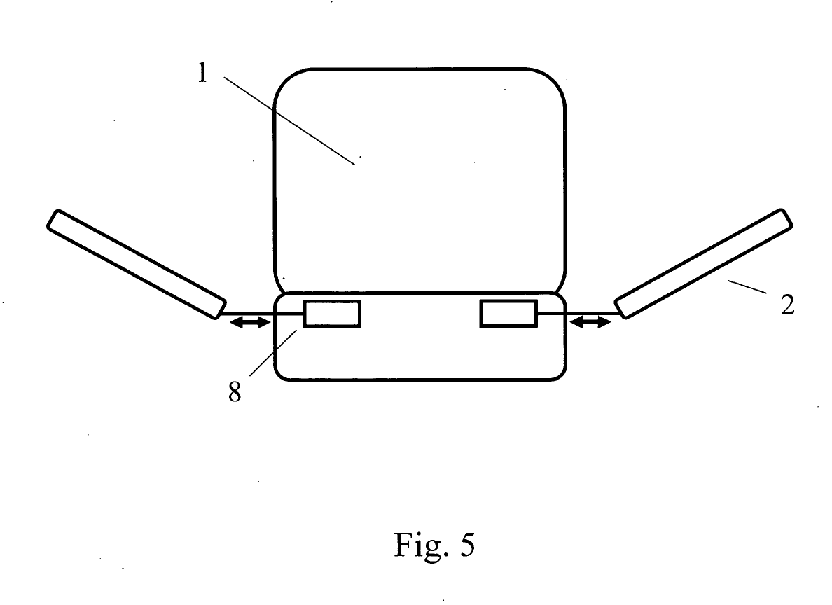

For vehicles with more complete safety systems and sensors, it is desirable to optimize the amount of lateral restraint for each occupant. As shown in FIG. 5, to truly optimize for a wide variety of vehicle sizes, it may be advantageous to adjust the restraints laterally as well as rotationally. Additional actuators 7 are shown which provide this additional adjustment. The most convenient implementation of actuator 7 is a motor driven screw. Other actuators will suggest themselves to one skilled in the art. The use of actuators 7 with appropriate sensing allow for the lateral restraint to be positioned at an optimum angle for a range of occupant sizes. During deployment the restraints could be moved inward until either contact or proximity to the occupant is sensed. Then the restraints could be rotated appropriately. Alternatively, particularly for the inboard side, the restraint could be always at the correct orientation, and simply moved in to the right position laterally. It also is advantageous to adjust the restraints vertically to accommodate different sized occupants. Thus another embodiment of the invention also includes vertical actuators. A preferred implementation of the vertical actuators is to use motors and occupant sensors to optimally position the restraints vertically for a particular occupant. Thus the invention may encompass rotational, lateral and vertical positioning of the restraints to best fit an occupant.

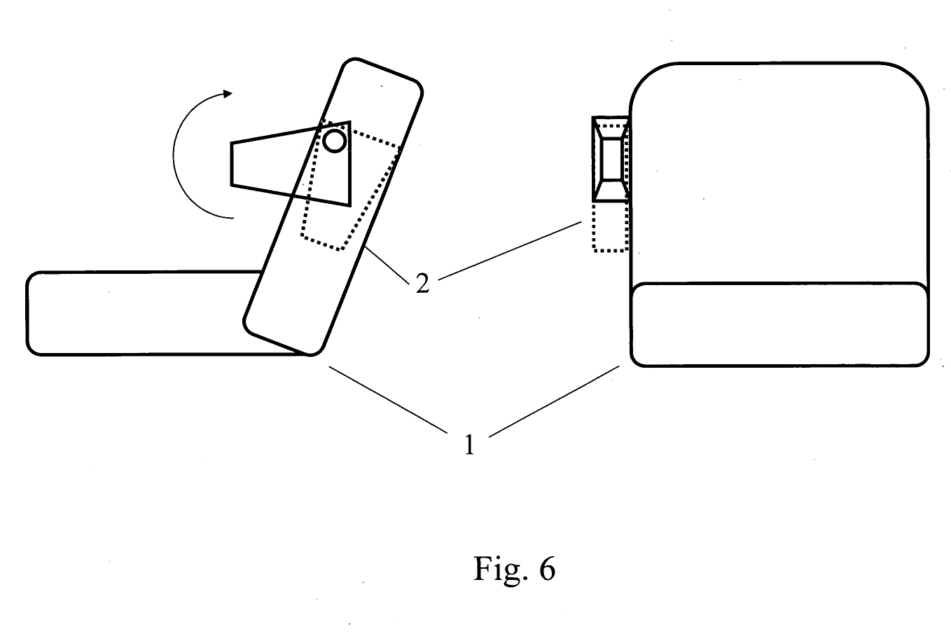

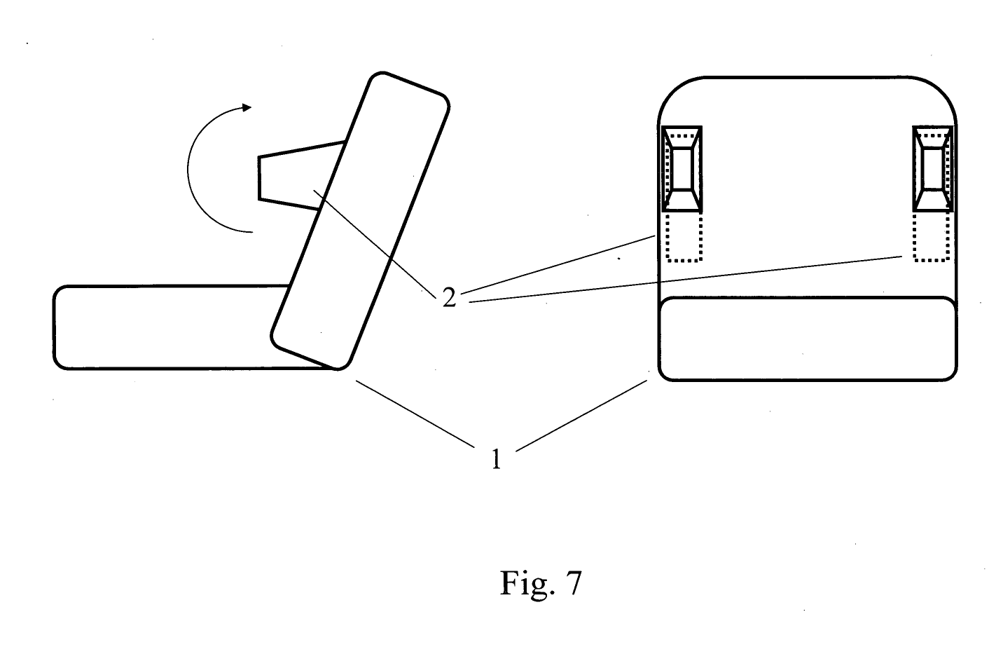

Although it may be desirable to fully deploy a lateral restraint in the event of am emergency, the fact is without sophisticated pre-collision detection, deployment of a restraint quickly enough to be effective may not be possible for side or oblique impacts. Thus another embodiment of the invention is to deploy the restraint whenever the vehicle is actually operating. This version requires that a designer factor in the loads that may be experienced in an impact, along with the requirement to operate the vehicle with the restraint deployed. One approach to this scenario is shown in FIG. 6. The restraint 2 is stowed flat against the side of the seat 1. The restraint is deployed by rotating the restraint into position vertically. The inventors feel that a vertically rotated restraint offers sufficient design choices for a skilled practitioner to meet the requirements for adequate load bearing, comfort and operability. Such a system provides effective lateral restraint during impact while not requiring pending impact activation and not impeding occupant egress/ingress. An alternative embodiment is shown in FIG. 7 where the restraint 2 is stowed recessed into the seat back 1. Also shown in FIG. 7 are restraints on both sides of the seat, which of course is also a possible implementation for the embodiment of FIG. 6. Other physical instantiations of restraint design will suggest themselves to one skilled in the art besides the two options shown in FIGS. 6 and 7, and should be considered within the scope of the invention.

For the embodiments of FIGS. 6 and 7 since deployment/stowage is a routine repetitive process, one-time actuators such as pyro devices are not suitable. A motor driven deployment is preferred. An automatic deployment/manual stowage scheme is possible, such as a spring driven deployment into a stop position, and release of the stop allowing for manual stowage. A manual override to release the restraint may also be desirable, to ensure that egress is available in the case of an accident or restraint system failure.

The restraint 2 of FIG. 6 or 7 should be stowed for any situation where an occupant is getting in or out of the seat 1, and deployed for any situation where the vehicle may be exposed to a collision, impact or other emergency. Various vehicle designers may wish to use utilize alternative definitions of a start operation event causing deployment of the restraint, and a stop operation event causing stowage of the restraint. These may vary from implementation to implementation. Deployment may be triggered by actions or combinations of actions such as vehicle movement, seat-belt activation, passenger detection by weight sensor or, car doors closed. The stop vehicle operation event may be triggered by actions or combinations of actions such as vehicle motion stopped, vehicle taken out of gear, seat belt removed or car door opened. Just what actions are chosen to trigger stowage of the restraint will depend on specific vehicle designer choices.

Since in the embodiments of FIGS. 6 and 7 the restraint is deployed whenever the vehicle is exposed to emergency risk, other safety systems may be integrated with the restraint. For instance the restraint could contain side airbags, in a variety of possible configurations, such as designed to deploy, with respect to the restraint, above, below, to the inside or any combination. The existence of semi-permanent restraints can be used to further design choices, such as seat belt type, seat width, or seat curvature, while maintaining adequate lateral restraint.

We claim:

1. a safety system for a vehicle, comprising:
a seat,
at least one sensor for detecting a condition requiring deployment of safety devices; and,
at least one lateral restraint wherein in response to a signal from the sensor, a side restraint is deployed on at least one side of the seat to reduce lateral displacement of the seat occupant, wherein the restraint is sized and designed to withstand loads in excess of 10 g.

2. The safety system of claim 1, wherein the lateral restraint is deployed by being rotated into position such that after deployment, the restraint serves as a side barrier.

3. The safety system of claim 2 wherein the lateral restraint is rotated by a motor.

4. The safety system of claim 3, wherein the motor is used for occupant controlled adjustment of the lateral restraint position during normal operation, and automatically rotates to a safety position in response to the sensor signal.

5. The safety system of claim 2 wherein the lateral restraint is rotated by spring rotator, such that the spring is released in response to the sensor signal.

6. The safety system of claim 2 wherein the lateral restraint is rotated by a pyrotechnic actuator, such that the pyrotechnic is fired in response to the sensor signal.

7. The safety system of claim 2 further comprising a locking device to secure the lateral restraint in the safety position.

8. The locking device of claim 7 wherein a stop is inserted when the restraint reaches the desired point of rotation.

9. The safety system of claim 1 wherein the lateral restraint is partially deployed when the seat is occupied, and fully deployed in response to the sensor signal.

10. The safety system of claim 1 wherein the side restraint is unrolled in response to the sensor signal.

11. The safety system of claim 1 wherein;
the lateral restraint is part of the seat,
the seat is pre-stressed to assume a shape with lateral restraint deployed,
the seat is held in the non-deployed shape by a rigid internal structure, and;
the internal structure is rendered non rigid in response to the sensor signal such that the seat assumes a shape with lateral restraints deployed.

12. The safety system of claim 1 wherein the sensor signal is triggered by at least one of;
a rollover condition,
a side or oblique impact,
a anticipatory event, or;
the vehicle commencing operation.

13. The safety system of claim 12 where the anticipatory event is at least one of;
a vehicle side slip,
high lateral deceleration,
high yaw rate,
high roll rate,
high deceleration braking; or,
pre-collision detection.

14. The safety system of claim 12 where if no collision results from the anticipatory event, the lateral restraints are returned. to the position before deployment.

15. The safety system of claim 1 wherein deployment includes the lateral restraints being moved laterally until they contact or are in proximity to the occupant.

16. The safety system of claim 1 wherein deployment includes the lateral restraints being moved vertically to adjust for occupants of varying size.

17. A safety system for a vehicle, comprising;
at least one lateral restraint, sized and designed sufficient to withstand impact level stresses, wherein the restraint is deployed into a safety position at a start vehicle operation event, and moved into a stowed position at a stop vehicle operation event.

18. The safety system of claim 17 wherein the start vehicle operation event is defined as any combination of;
vehicle movement,
seat-belt use,
passenger detection by weight sensor; or,
car doors closed; and the stop vehicle operation event is any combination of:
vehicle motion stopped,
vehicle taken out of gear,
seat belt removed; or,
car door opened.

19. The safety system of claim 17 wherein the stowed position of the restraint is at least one of:
attached flat to a side of the seat back; or
recessed into the seat back; wherein the deployment is vertical rotation by motor.

20. The safety system of claim 17 wherein lateral restraint may optionally contain side airbags, either positioned to deploy above the restraint, below the restraint, between the restraint and a seat occupant, or any combination therein.
